(19) United States
(12) Patent Application Publication
(10) Pub. No.: US 2009/0005041 A1
(43) Pub. Date: Jan. 1, 2009

(54) DYNAMIC NETWORK SELECTION BY A WIRELESS DEVICE

(75) Inventors: Paul D. Steinberg, Bartlett, IL (US); Michael D. Kotzin, Buffalo Grove, IL (US); Craig P. Reilly, Bartlett, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/769,795

(22) Filed: Jun. 28, 2007

(51) Int. Cl. H04Q 7/20

(52) U.S. Cl. 455/435.2

(57) ABSTRACT

A method, wireless device, and wireless communication system for dynamically selecting a network for communicating data over. The method includes initiating a search for a new access network (102). A network information request is transmitted to an information processing system in response to the determining (610). Network information associated with at least one access network is received (618) from the information processing system (120). The new access network (102) is selected based on the received network information. The new access network (102) is then connected to.

### REFERENCE(S) TO RELATED APPLICATION(S)

This application is related to a co-pending application entitled “SECURITY BASED NETWORK ACCESS SELECTION,” filed on even date herewith, assigned to the assignee of the present application, and hereby incorporated by reference.

### FIELD OF THE INVENTION

The present invention generally relates to the field of wireless communications, and more particularly relates to dynamically selecting a network by a wireless device using various policies.

### BACKGROUND OF THE INVENTION

Wireless communication systems have evolved greatly over the past few years. Current wireless communication systems provide multiple services such as cellular services, data services, and the like. These services can be provided by various access networks within a wireless communication system. Therefore, a wireless device may detect numerous networks that it can connect to. One problem with current wireless systems is that an efficient method for a wireless device to select a network from multiple networks does not exist. Assisted handoff methods exist in cellular systems, but they are not optimum for numerous heterogeneous networks. These assisted handoff methods also do not provide policy management or a way for wireless devices to collaboratively assert conditions for sharing network information.

Therefore a need exists to overcome the problems with the prior art as discussed above.

### SUMMARY OF THE INVENTION

Briefly, in accordance with the present invention, disclosed are a method, information processing system, and wireless communication system for dynamically selecting a network for communicating data over. The method includes initiating a search for a new access network. A network information request is transmitted to an information processing system in response to this determination. Network information associated with at least one access network is received from the information processing system. The new access network is selected based on the received network information. Connection to the new access network is then made.

In yet another embodiment, a wireless device is disclosed. The wireless device includes a memory and a processor that is communicatively coupled to the memory. The wireless device also includes an access network manager that is communicatively coupled to the memory and the processor. The access network manager is adapted to initiate a search for a new access network. A network information request is transmitted to an information processing system in response to this determination. Network information associated with at least one access network is received from the information processing system. The new access network is selected based on the received network information. Connection to the new access network is then made.

In another embodiment, the wireless device can also transmit information that it has observed about all potential access networks to the information processing system. This information is used by the information processing system to construct or improve its network information.

In yet another embodiment a wireless communication system is disclosed. The wireless communication system includes a plurality of access networks and at least one information processing system communicatively coupled to at least one access network in the plurality of access networks. The wireless communication system also includes a plurality of wireless devices. Each wireless device is communicatively coupled to at least one access network in the plurality of access networks. At least one wireless device in the plurality of wireless devices comprises a memory and a processor that is communicatively coupled to the memory. The wireless device also includes an access network manager that is communicatively coupled to the memory and the processor. The access network manager is adapted to initiate a search for a new access network. A network information request is transmitted to an information processing system in response to the determining. Network information associated with at least one access network is received from the information processing system. The new access network is selected based on the received network information. Connection to the new access network is then made.

An advantage of the foregoing embodiments of the present invention is that wireless devices are able to manage the selection of access networks. The wireless device is able to base the network selection on a variety of factors ranging from access type to service cost. Another advantage of embodiments of the present invention is that a wireless device can retrieve information associated with networks near its current location. This allows the wireless device to make its network selection without having to query each and every detected network. Another advantage is that the information available to the wireless device is a composition from many other devices thus improving accuracy and resolution and availability of information (e.g., when a device is in an area for the first time, there is information present based upon inputs accumulated from other mobiles). Also, there is a predictive aspect of this, for example, a wireless device collects information surrounding its current location. As the wireless device moves (e.g., calculated with GPS assistance, accelerometers, etc.) it can trigger actions relative to the information and its motion vector.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram illustrating a wireless communications system according to an embodiment of the present invention;

FIG. 2 illustrates one example of entries within a network database residing on a wireless device according to an embodiment of the present invention;

FIG. 3 illustrates one example of entries within a registry database residing on an information processing system according to an embodiment of the present invention;

FIG. 4 is a block diagram illustrating a wireless communication device according to an embodiment of the present invention;

FIG. 5 is a block diagram illustrating an information processing system according to an embodiment of the present invention;

FIG. 6 is an operational flow diagram illustrating a process of a wireless device dynamically selecting a network according to an embodiment of the present invention;

FIG. 7 is an operational flow diagram illustrating a process of a registry server providing a wireless device network information according to an embodiment of the present invention;

FIG. 8 is an operational flow diagram illustrating a process of a registry server updating its registry database according to an embodiment of the present invention; and

FIG. 9 is an operational flow diagram illustrating a process of a service provider server transmitting update information to a registry server according to an embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term coupled, as used herein, is defined as connected, although not necessarily directly, and not necessarily mechanically.

The term “wireless device” is intended to broadly cover many different types of devices that can wirelessly receive signals, and optionally can wirelessly transmit signals, and may also operate in a wireless communication system. For example, and not for any limitation, a wireless communication device can include any one or a combination of the following: a cellular telephone, a mobile phone, a smart phone, a two-way radio, a two-way pager, a wireless messaging device, a laptop/computer, automotive gateway, residential gateway, and the like.

Wireless Communication System

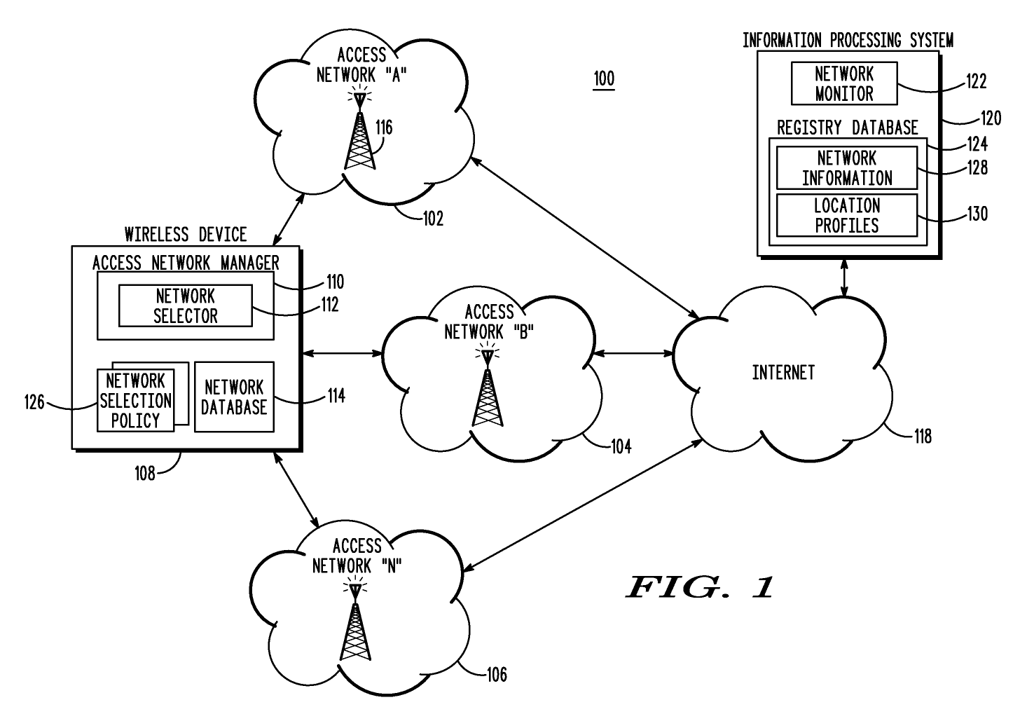

According to an embodiment of the present invention, as shown in FIG. 1, a wireless communication system 100 is illustrated. FIG. 1 shows the wireless communication system 100 comprising a plurality of access networks 102, 104, 106. The access networks 102, 104, 106, in one embodiment, can comprise one or more circuit services networks and/or data packet networks.

Further, the communications standard of the access networks 102, 104, 106 comprises Code Division Multiple Access (CDMA), Time Division Multiple Access (TDMA), Global System for Mobile Communications (GSM), General Packet Radio Service (GPRS), Frequency Division Multiple Access (FDMA), IEEE 802.16 family of standards, 802.11 family of standards, Orthogonal Frequency Division Multiplexing (OFDM), Orthogonal Frequency Division Multiple Access (OFDMA), Wireless LAN (WLAN), WiMAX or the like. Other applicable communications standards include those used for Public Safety Communication Networks including TErrestrial TRunked Radio (TETRA).

Each access network 102, 104, 106 can be owned and operated by separate wireless service providers. Alternatively, two or more of the access networks 102, 104, 106 can be owned and operated by the same wireless service provider. For example, a single wireless provider can own Access Network A 102, which can be a WiMAX system, and can also own Access Network B 104, which can be a cellular system.

The wireless communication system 100 supports any number of wireless devices 108 which can be single mode or multi-mode devices. Multi-mode devices are capable of communicating over multiple access networks with varying technologies. For example, a multi-mode device can communicate concurrently over a circuit services network and a packet data network that can comprise an Evolution Data Only (“EV-DO”) network, a General Packet Radio Service (“GPRS”) network, a Universal Mobile Telecommunications System (“UMTS”) network, an 802.11 network, an 802.16 (WiMAX) network, or the like. The wireless device 108, in one embodiment, connects to a public network 118 such as the Internet through the access networks 102, 104, 106.

In one embodiment, the wireless device 108 includes an access network manager 110 that includes a network selector 112. The wireless device 108 also includes a network database 114 and one or more optional network selection policies 126. A network selection policy 126 allows a user to control how the network selector 112 chooses a target network by including, for example, a list of preferred network providers, best-effort bandwidth vs. cost, etc. A network selection policy 126 can also be downloaded from an information processing system 120 or from a service provider.

A network selection policy 126 can be a user policy that is defined and entered by a user. Another type of policy is a network provider policy that is defined and provided by a user's home service provider. This type of policy can be downloaded from a registry server or via other means in the operator's network. Another policy type is a network policy that is defined and provided by the various potential serving networks that may be provided by an operator other than the user's home operator. Policies of this type can be retrieved from a registry server.

The access network manager 110, network selector 112, and network database are discussed in greater detail below. The wireless system 100 also includes one or more base stations (or access points) 116 that reside within each access network 102, 104, 106. It should be noted that access networks 102, 104, 106 also include additional components (not shown) such as controllers, transport/interconnect gear, network management modules, and the like that should be known to those of ordinary skill in the art.

One or more information processing systems 120 communicate with the wireless device 108 via the public network 118. In one embodiment, the information processing system 120 functions in part as a registry server. However, the information processing system 120 is not limited to a registry server. Although, FIG. 1 shows the information processing system 120 as communicatively coupled to a public network 118, it can also be communicatively coupled to a carrier intranet. For example, a single operator may have several different networks (e.g., a CDMA network, WiMAX network, and the like). The single operator can implement the present invention within its own networks to direct a wireless device to a network that can offer a better end-user experience than another network. Therefore, in this embodiment the information processing system 120 can be located within the operator's network.

In one embodiment, the information processing system 120 is a registry server that communicates network information to and receives network information from the wireless device 108. The information processing system 120, in one embodiment, includes a network monitor 122 and a registry database 124, both of which are discussed in greater detail below. The information processing system 120 can be a network component residing within the wireless communications system 100. However, the information processing system 120 can also be a third-party system that the wireless device 108 subscribes to.

Dynamic Selection of Networks

As discussed above, multi-mode wireless devices are capable of communicating on more than one type of access network. One advantage of various embodiments of the present invention is that they may allow a wireless device 108 to dynamically and optimally select an access network/serving network 102 when multiple serving networks are detected. In one embodiment, the wireless device 108 can manage the selection of an access network 102 based on policy, quality of service, cost, and the like as defined by a service provider or a user of the wireless device 108.

Each access network 102 can broadcast real-time information about their conditions, charging factors, and the like. For example, each access network 102 can broadcast information such as available bandwidth for air interface and backhaul, cost charges for a time of day, capabilities for a current location of a wireless device in proximal areas, and the like. The current location of a wireless device 108 or areas proximal to the device 108 can be determined/estimated by an access network based on trajectory vectors received from the wireless device 108 (or the device might use GPS or Time Difference of Arrival in determining its location as well as motion vectors). The access network 102 can broadcast this information periodically or in response to various triggers occurring.

The access network manager 110 within the wireless device 108 monitors and records the network information received from the access network 102 that the device 108 is currently communicating with. Other information such as RF conditions, QoS, and the like is also monitored by the access network manager 110. In one embodiment, the recorded information is stored within the network database 114. In another embodiment, the information processing system 120 can monitor this information via its network monitor 122 and record the network information 128 within the registry database 124. In one embodiment, the wireless device 108 communicates with the information processing system 120 to upload its recorded network information. For example, the wireless device 108 transmits its location (e.g., trajectory vector), current link conditions, measurements that can include information about proximal systems to the information processing system 120, charging information, and the like.

Based on the location information received from the wireless device 108, the information processing system 120 can create location profiles 130 that are stored within the registry database 124. For example, the information processing system 120 accumulates network information from multiple wireless devices 108 and acts as a repository for network information. The information received from various wireless devices 108 can be averaged to create profiles for each access network 102, locations within the access network 102, and the like.

The wireless device 108 can use the information collected by the information processing system 120 to dynamically select a new access network. For example, the wireless device 108 can include distance or time based triggers that indicate when a new target access network is required. A distance/motion trigger, in one embodiment, is a trigger used by the wireless device 108 to detect when it has traveled a given distance. The distance trigger can be set once the wireless device 108 registers with an access network 102. If the wireless device 108 determines that it is at a distance from the base station 116 that is greater than a given threshold it determines that a new access network 102 is required. The time based trigger, in one embodiment, is also set when the wireless device registers with an access network 102. After a given amount of time has passed while the device 108 is registered with the network 102, the wireless device 108 determines that a new access network 102 is required.

By using a motion/location based trigger, this allows the wireless device 108 to be more power efficient (e.g., the device does not have to aggressively operate multiple radios to update itself on the surrounding conditions). It should be noted that the motion of interest is not just distance from the serving base station but also includes the direction the device is traveling and is also relative to the other available networks. For example, a device 108 on a cellular network can go east 100 meters to find a (more desirable) WiFi serving network and implements a trigger based on those requirements. The same device might go west 500 meters to encounter a (more desirable) WiMAX network and implements a trigger based on those requirements.

Also a wireless device 108 may desire to trigger network detection based upon current RF conditions. For example, a wireless device 108 might be on its preferred network but can encounter an RF fade. The RF fade may necessitate the wireless device 108 to consult the database 120 and to make a decision on an alternate network to maintain user/application service requirements.

When the wireless device 108 determines that a new access network is required, it can connect to the information processing system 120 and request a location profile 130 from the information processing system 120. In other words, the wireless device 108 requests information associated with nearby networks based on its current geographical location. The wireless device 108 can request information for all networks within a given distance, for a particular access type, or the like. The information returned by the information processing system 120 can identify proximal target networks and information such as cost, bandwidth availability, Quality of Service factors, coverage capabilities relative to the device's current location, and the like.

The wireless device 108 via the network selector 112 uses the network information received from the information processing system 120 to make optimized local decisions on which network (if any) to dynamically select for communicating over. One advantage of various embodiments of the present invention is that the wireless device 108 does not have to query every available network to retrieve information for making a network selection and allows the wireless device 108 to manage power consumption since it does not have to keep multiple radios active search and evaluate conditions. The information processing system 120 provides the wireless device 108 with network information 128 needed to dynamically select a network.

When the wireless device 108 receives the network information from the information processing system 120, the network selector 112, in one embodiment, computes a minimum performance metric PS for its current serving network at the device's current location. The network selector 112 can also compute a performance metric, PS, for any determined/estimated locations after a period of time T. The performance metric PS, in one embodiment, is a composite metric. However, individual metrics can also be computed and a weighted comparison with threshold restrictions can be performed at a later comparison step. Performance metrics take into account cost, speed, quality of the link, affinity factors (e.g., volume discounts), device impacts (e.g., battery loading), and the like.

Once the minimum performance metric PS is determined, the network selector 112 computes minimum performance metrics P1 through PN for alternative target systems identified in the information received from the information processing system 120 for the device's current location and any likely locations after time T. The network selector 112 compares P1 through PN to PS and selects the network with the highest performance metric. If the highest performance metric belongs to a different system, the wireless device may then sample that RF network (e.g., start a second radio) and upon finding suitable conditions, requests to transition to that system.

Also, a user can control how the network selector 112 chooses a target network. For example, a user can setup a policy 126 that the network selector is to follow when selecting a network. The network selection policy 126 can include a list of preferred network providers, best-effort bandwidth vs. cost, etc.

As discussed above, when the wireless device 108 connects to the information processing system 120, it can request target information for networks providing a specific access type such as WiMAX. The information processing system 120 provides information based on the location and motion vectors from a given location. The device 108 then uses this in real time to make decisions as a function of surrounding conditions and as a function of the devices motion

However, the information received by the information processing system 120 may not include any target networks providing the requested access type. Also, the information processing system 120 may include potential targets, but the network operator for a given target is not provisioned in the device's local policy 126. If this situation occurs, the network selector 112 does not select a new network. In other words, the wireless device 108 remains on its current serving network. The distance and time triggers can then be reset.

In another embodiment, the information processing system 120 can request information from wireless devices 108 to update its registry database 124. For example, when the wireless 108 determines that a distance/time based trigger has expired it connects to the information processing system 120. The wireless device 108 provides authentication, location, and capability to the information processing system 120 and a request for alternate access type B target information. In other words, the wireless device 108 requests network information associated with networks providing an access type B. The information processing system 120 transmits network information to the wireless device 108 that includes target identifiers, frequencies associated with each target network, provider information, pricing information, and the like. In one embodiment, the network information 128 transmitted by the information processing system 120 is filtered by the information processing system 120 based on the capability information sent by the wireless device 108.

The wireless device 108 uses the received network information 128 to perform a limited scan of the indicated target networks. Based on the scan and any policies, the wireless device 108 dynamically selects a network and transitions to the selected network. In one embodiment, the information processing system 120 can request that the wireless device 108 transmit information associated with its network scans. This information is used by the information processing system 120 to build, maintain, and update (e.g., improve and add resolution/granularity) its registry database 124. For example, the information processing system 120 keeps track of the age of the database 124 and selects subscribers periodically to refresh the information based on the age of the data and the wireless device 108 location or capability.

The information processing system 120 incorporates the received results from the wireless device 108 into the registry database 124 to improve the target information for subsequent requests. The information processing system 120 can also incorporate location, weighting based on freshness of the information, outlier elimination, known mobile reporting quirks, or reported network outages to process the set of reports used to build replies for each geographic coordinate.

In another embodiment, the target network information received from the information processing system 120 may not include any potential target networks for the wireless device's current location and may only include a policy. However, the wireless device 108 can perform a thorough scan of networks in its area based on its local policy. If the wireless device 108 identifies potential target networks (e.g., target networks that may or may not meet criteria defined by the local policy) information associated with these networks recorded by the wireless device 108 can be transmitted to the information processing system 120 to populate the registry database 124. The registry database 120 incorporates these results to further improve target information for subsequent requests.

Also, the information processing system 120 can push update information to a wireless device without receiving a request from a device 108. For example, an operator maintaining the information processing system 120 becomes aware of an impending pricing change in one or more of the access networks 102. The information processing system 120 is updated, for example, by using an OSS/BSS interface (not shown). The information processing system 120 can then update wireless devices 108 in real-time via a push procedure over IP (e.g., IP techniques can use broadcast and multicast). Alternatively, the information processing system 120 can publish the existing prices along with the new prices prior to the price change taking effect. Wireless devices 108 can retrieve this information from the registry sever 120, thereby eliminating the need for the information being pushed to the devices.

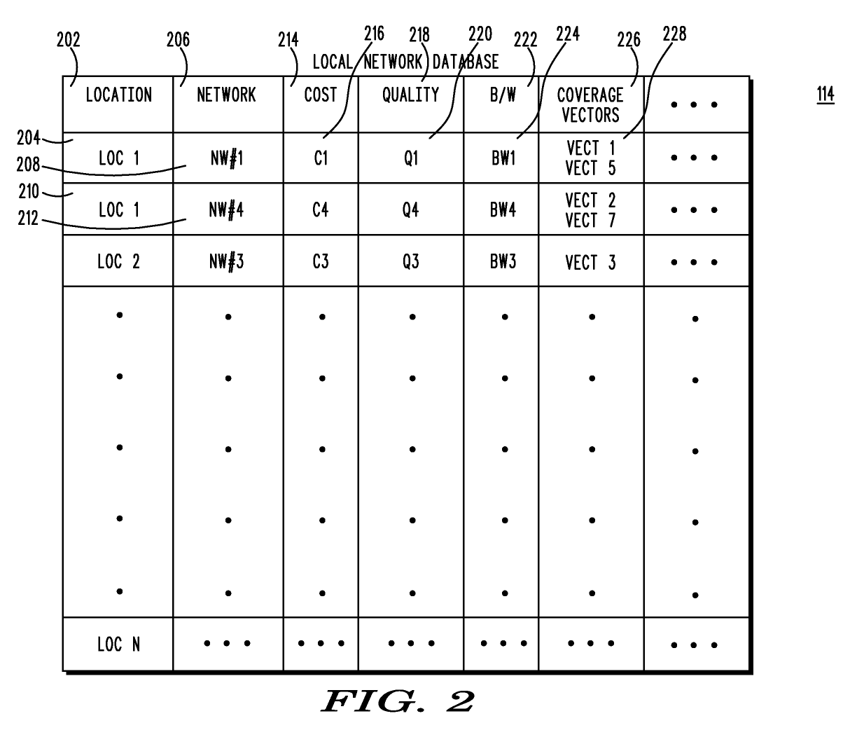

FIG. 2 shows one example of the network database 114 residing in the wireless device 108. As discussed above, the network database 114 includes information associated with access networks detected or connected to by the wireless device 108 in various geographic locations. It should be noted that the network database 114 shown in FIG. 2 is only one example and is not limited to the columns, fields, and configuration shown. In one embodiment, the network database 114 includes a “Location” column 202 that comprises one or more entries that identify a geographical location. For example, a first entry 204 under the “Location” column 202 includes a geographical location identifier of “Loc 1”. The wireless device 108 records its geographical location/area either when it detects or connects with an access network 102 or when the device moves into a new location/area.

The network database 114 also includes a “Network” column 206 that includes one or more entries that identifies a network. For example, a first entry 208 under the “Network” column 206 includes an identifier “NW #1” that identifies a first network. It should be noted that the wireless device 108 can detect or connect to more than one network at a single location. For example, FIG. 2 shows a second entry 210 under the “Location” column 202 that is also associated with location Loc 1 and a second entry 212 under the “Network” column 206 that identifies network “NW #4”. Therefore, the wireless device 108 has detected network NW #1 and network NW #4 at location Loc 1. It should be noted that the network database 114 can include generic/communal information as well as device-specific information allowing a service provider to further customize/improve a given user's service.

The network database 114 can also include network information that has been recorded by the wireless device 108. In one embodiment, a “Cost” column 214 can be included in the network database 114 that indicates a cost associated with an identified network. For example, FIG. 2 shows a first entry 216 under the “Cost” column 214 that indicates a cost factor of C1 associated with network NW #1. A “Quality” column 218 can also be included in the network database 114. The “Quality” column 218 indicates one or more QoS factors associated with a network that the wireless device 108 has detected. For example, a first entry 220 under the “Quality” column indicates that network NW #1 at location Loc 1 has a quality of Q1.

A “Bandwidth” column 222 can also be included within the network database 114 that indicates available bandwidth for air interface and/or backhaul traffic. For example, a first entry 224 under the “Bandwidth” column 222 indicates that network NW #1 has a bandwidth of BW 1. In another example, a “Coverage Vectors” column 226 can be included within the network database 114 that indicates potential coverage areas for a network. For example, a first entry 228 under the “Coverage Vectors” column 224 indicates that network NW #1 has potential coverage vectors of Vect 1 and Vect 5.

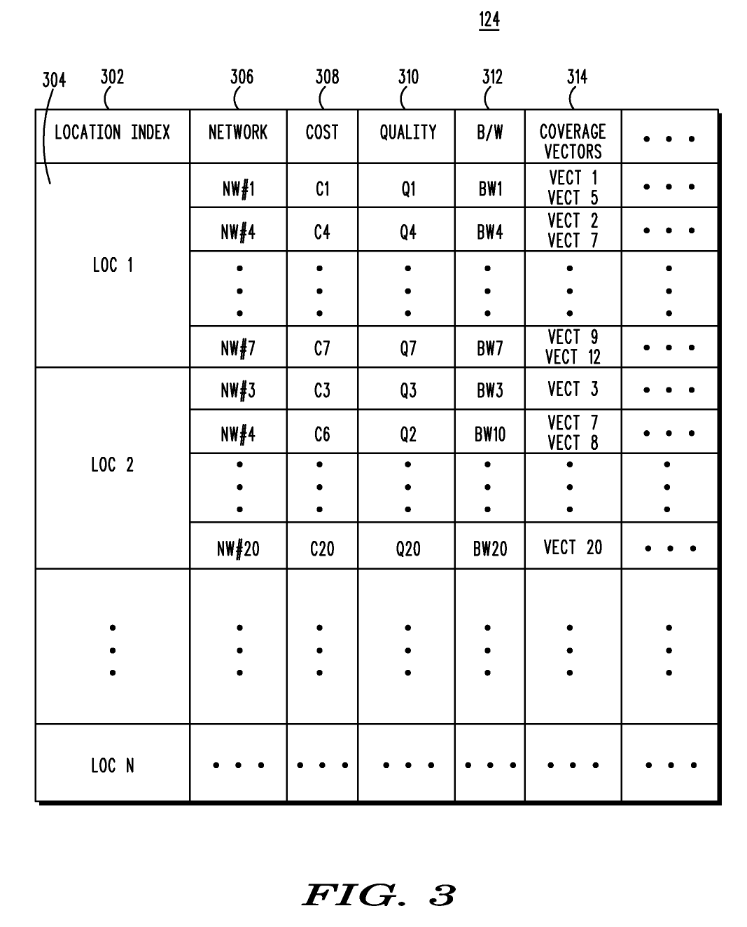

FIG. 3 shows one example of the registry database 124 residing in the information processing system 120. It should be noted that the registry database 124 is not limited to residing on the information processing system 120. For example, the registry database 124 can also reside on another information processing system communicatively coupled to the information processing system 120.

As discussed above, the registry database 124 includes information associated with access networks that has been collected from multiple wireless devices 108. For example, the registry database 124 can include information for each network detected or connected to by multiple wireless devices for a given geographic location. In one embodiment, information collected from each wireless device 108 for a geographic location is entered into the registry database 124 as a separate entry, as shown in FIG. 3. However, the information processing system 120 can also aggregate and average collected information and store this averaged information in the registry database 124. It should be noted that the registry database 124 shown in FIG. 3 is only one example and is not limited to the columns, fields, and configuration shown.

In one embodiment, the registry database 124 includes a “Location Index” column 302 that comprises a location index for one or more geographical locations. For example, FIG. 3 shows a first entry 304 under the “Location Index” column 302 that includes a location index for the geographical location Loc 1. In other words, the location index of location Loc 1 includes network information received from wireless devices that is associated with various networks throughout the location Loc 1. In one embodiment, the information associated with each network is similar to the information discussed above with respect to the network database 114 in the wireless device 108.

For example, a wireless device transmits the network information within its network database 114 to the information processing system 120. The registry server enters the received network information into the registry database 124. Therefore, the registry database includes a “Network” column 306 that includes one or more entries that identifies a network; a “Cost” column 308 that indicates a cost associated with an identified network; a “Quality” column 310 that indicates one or more QoS factors associated with a network; a “Bandwidth” column 312 that indicates available bandwidth for air interface and/or backhaul traffic; a “Coverage Vectors” column 314 that indicates potential coverage areas for a network; and the like. This information is then used by the access network manager 110 to construct the motion-based triggers. These information types have been discussed above in greater detail.

Wireless Communication Device

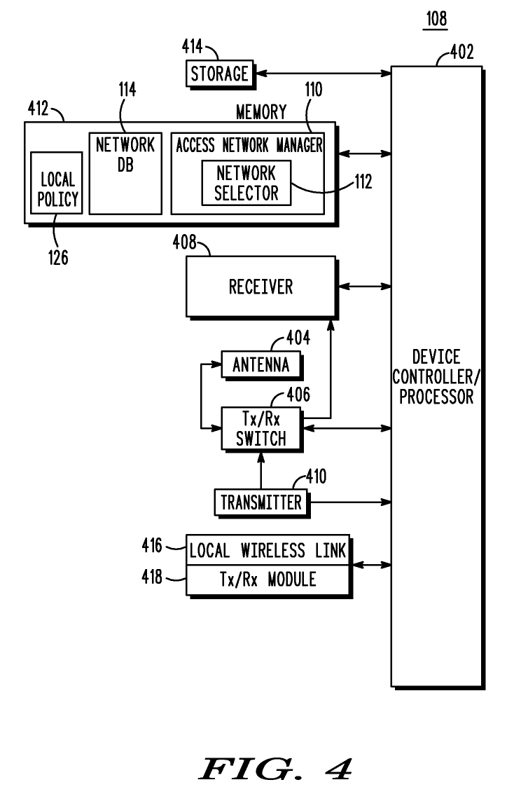

FIG. 4 is a block diagram illustrating a detailed view of the wireless device 108 according to an embodiment of the present invention. It is assumed that the reader is familiar with wireless communication devices. To simplify the present description, only that portion of a wireless communication device that is relevant to the present invention is discussed.

The wireless device 108 operates under the control of a device controller/processor 402, that controls the sending and receiving of wireless communication signals. In receive mode, the device controller 402 electrically couples an antenna 404 through a transmit/receive switch 406 to a receiver 408. The receiver 408 decodes the received signals and provides those decoded signals to the device controller 402.

In transmit mode, the device controller 402 electrically couples the antenna 404, through the transmit/receive switch 406, to a transmitter 410. It should be noted that in one embodiment, the receiver 408 and the transmitter 410 are a multi-mode receiver and a multi-mode transmitter for receiving/transmitting on a variety of access network technologies. In another embodiment a separate receiver and transmitter is used for each access network technology.

The device controller 402 operates the transmitter and receiver according to instructions stored in the memory 412. These instructions include, for example, a neighbor cell measurement-scheduling algorithm. The memory 412, in one embodiment, also includes the access network manager 110, network selector 112, network database 114, and any local network selection policies 126 discussed above. The wireless device 108, also includes non-volatile storage memory 414 for storing, for example, an application waiting to be executed (not shown) on the wireless device 108. The wireless device 108, in this example, also includes an optional local wireless link 416 that allows the wireless device 108 to directly communicate with another wireless device without using a wireless network (not shown). The optional local wireless link 416, for example, is provided by Bluetooth, Infrared Data Access (IrDA) technologies, or the like.

The optional local wireless link 416 also includes a local wireless link transmit/receive module 418 that allows the wireless device 108 to directly communicate with another wireless device such as wireless communication devices communicatively coupled to personal computers, workstations, and the like. It should be noted that the optional local wireless link 416 and the local wireless link transmit/receive module 418 can be used to communicate over one or more access networks 102.

Information Processing System

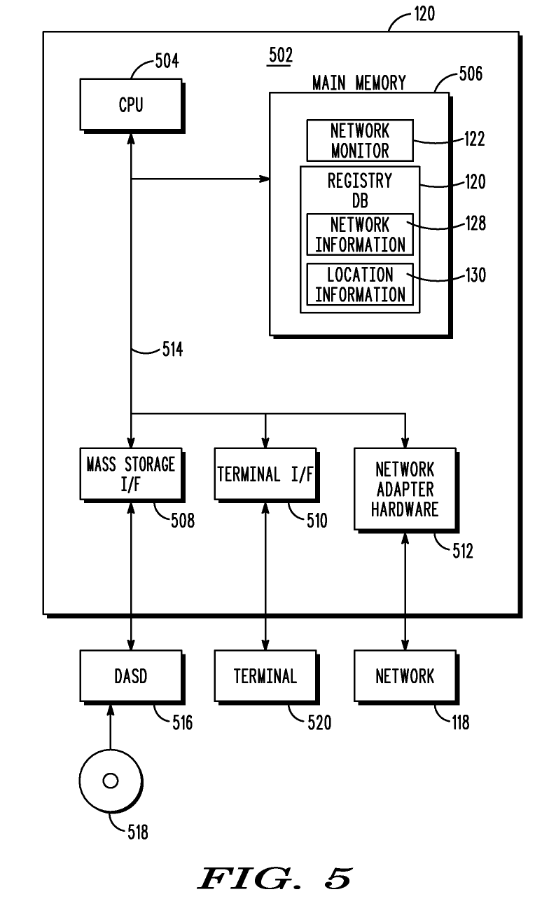

FIG. 5 is a block diagram illustrating a more detailed view of the information processing system 120 according to an embodiment of the present invention. The information processing system 120 is based upon a suitably configured processing system adapted to implement the embodiment of the present invention. For example, a server comprising one or more database management systems, a personal computer, workstation, or the like, may be used. The information processing system 120 includes a computer 502. The computer 502 has a processor 504 that is connected to a main memory 506, a mass storage interface 508, a terminal interface 510, and network adapter hardware 512. A system bus 514 interconnects these system components.

The main memory 506 includes the network monitor 122 and the registry database 124. These components have been discussed in greater detail above. Although illustrated as concurrently resident in the main memory 506, it is clear that respective components of the main memory 506 are not required to be completely resident in the main memory 506 at all times or even at the same time. One or more of these components can be implemented as hardware. In one embodiment, the information processing system 120 utilizes conventional virtual addressing mechanisms to allow programs to behave as if they have access to a large, single storage entity, referred to herein as a computer system memory, instead of access to multiple, smaller storage entities such as the main memory 506 and data storage device 516. The data storage device 516 can store data on a hard-drive or media such as a CD 516. Note that the term “computer system memory” is used herein to generically refer to the entire virtual memory of the information processing system 120.

Although only one CPU 504 is illustrated for computer 502, computer systems with multiple CPUs can be used equally effectively. Embodiments of the present invention further incorporate interfaces that each includes separate, fully programmed microprocessors that are used to off-load processing from the CPU 504. Terminal interface 510 is used to directly connect one or more terminals 520 to computer 502 to provide a user interface to the information processing system 120. These terminals 520, which are able to be non-intelligent or fully programmable workstations, are used to allow system administrators and users to communicate with the information processing system 120. The terminal 520 is also able to consist of user interface and peripheral devices that are connected to computer 502 and controlled by terminal interface hardware included in the terminal I/F 510 that includes video adapters and interfaces for keyboards, pointing devices, and the like.

An operating system (not shown) included in the main memory is a suitable multitasking operating system such as Linux, UNIX, Windows XP, and Windows Server 2003. Embodiments of the present invention are able to use any other suitable operating system. Some embodiments of the present invention utilize architectures, such as an object oriented framework mechanism, for executing instructions of the components of operating system (not shown) on any processor located within the information processing system 120.

The network adapter hardware 512 is used to provide an interface to the public network 118. Embodiments of the present invention are able to be adapted to work with any data communications connections including present day analog and/or digital techniques or via a future networking mechanism. Although the embodiments of the present invention are described in the context of a fully functional computer system, those of ordinary skill in the art will appreciate that embodiments are capable of being distributed as a program product via floppy disk or optical disk, e.g., CD/DVD 518, or other form of recordable media, or via any type of electronic transmission mechanism.

It should be noted that that a plurality of information processing systems 120 may be utilized by a present invention scaling the system. For example, each system may serve a particular geographic area and include that part of the database 124. A front-end, load-balancer/director can be used to direct wireless devices to the right servers based upon information needed and server loading.

Process of Dynamically Selecting a Network by a Wireless Device

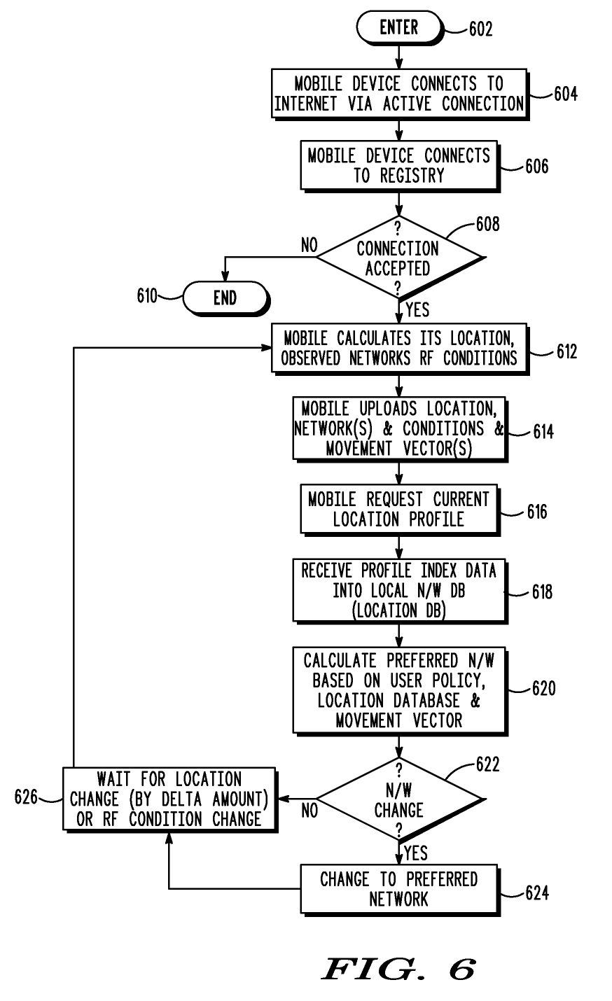

FIG. 6 is an operational flow diagram illustrating a process of a wireless device 108 dynamically selecting a network 102. The operational flow diagram of FIG. 6 begins at step 602 and flows directly to step 604. The wireless device 108, at step 604, connects to the Internet 118 or operator intranet via a current active connection. The wireless device 108, at step 606, connects to the information processing system 120. The wireless device 108, at step 608, determines if the connection to the information processing system 120 was accepted. If the result of this determination is negative, the control flow ends at step 610. If the result of this determination is positive, the wireless device 108, at step 612, determines its location, observed networks, RF conditions of each network, and the like.

The wireless device 108, at step 614, uploads the recorded network information along with a movement vector to the information processing system 120. The wireless device 108, at step 616, requests a location profile for its current location. The requested profile (if available), at step 618, is received from the information processing system 120. The wireless device 108, at step 620, dynamically selects a preferred network based on a local policy (if any), location, movement vector, and the like. The wireless device 108, at step 622, determines if a network change is required to transition to the dynamically selected network. If the result of this determination is positive, the wireless device 108, at step 624, transitions to the selected network. The control flows to step 626. If the result of this determination is negative, the wireless device 108, at step 626, waits for a location change of a given distance/vector or an RF condition change where the control then returns to step 612.

Process of the Registry Server Sending Network Information to a Wireless Device

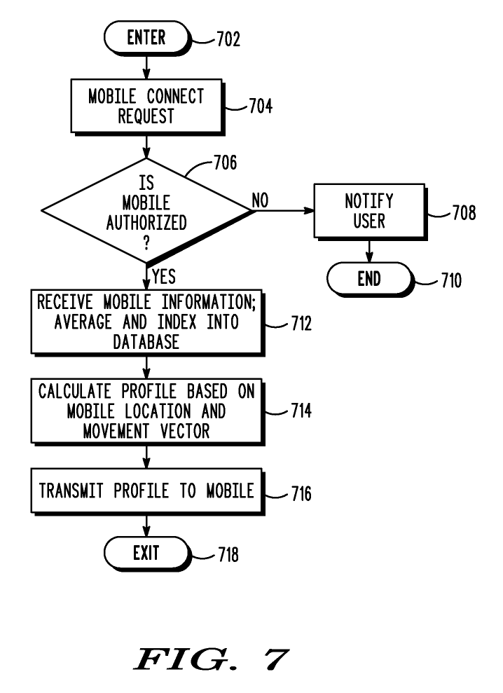

FIG. 7 is an operational flow diagram illustrating a process of the information processing system 120 providing a wireless device 108 network information. The operational flow diagram of FIG. 7 begins at step 702 and flows directly to step 704. The information processing system 120, at step 704, receives a request to connect from the wireless device 108. The information processing system 120, at step 706, determines if the wireless device 108 is authorized. If the result of this determination is negative, the information processing system 120, at step 708, notifies the wireless device 108 that it is not authorized to connect. The control flow then ends at step 710. If the result of this determination is positive, the information processing system 120, at step 712, receives network information and location information from the wireless device 108.

The received information is averaged and indexed into the registry server 124. The information processing system 120, at step 714, determines a profile to send to the wireless device 108 based on the location and movement vector of the wireless device 108. The information processing system 120, at step 716, transmits the profile to the wireless device 108. The control flow ends at step 718.

Process of the Registry Server Updating a Registry Database

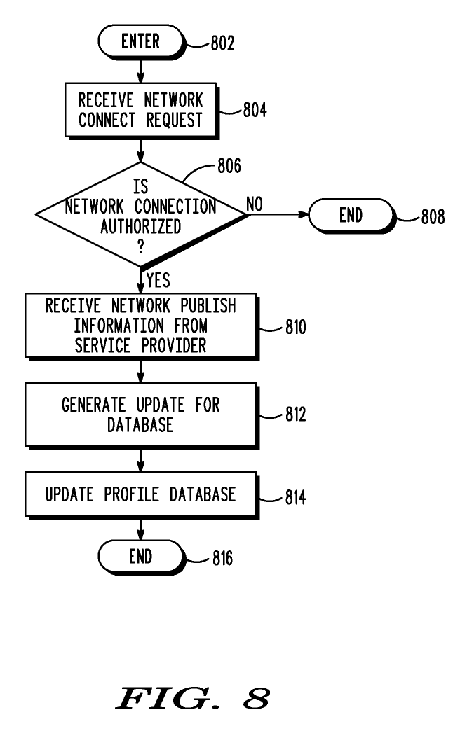

FIG. 8 is an operational flow diagram illustrating a process of the information processing system 120 updating its registry database 124. The operational flow diagram of FIG. 8 begins at step 802 and flows directly to step 804. The information processing system 120, at step 804, requests a network connection with a service provider. The information processing system 120, at step 806, determines if the network connection has been authorized. If the result of this determination is negative, the control flow ends at step 808. If the result of this determination is positive, the information processing system 120, at step 810, receives network publish information from the service provider. The information processing system 120, at step 812, generates an update for its registry database 124. The registry database 124, at step 814, is updated. The control flow then exits at step 816.

Process of the a Service Provider Publishing Information to the Registry Server

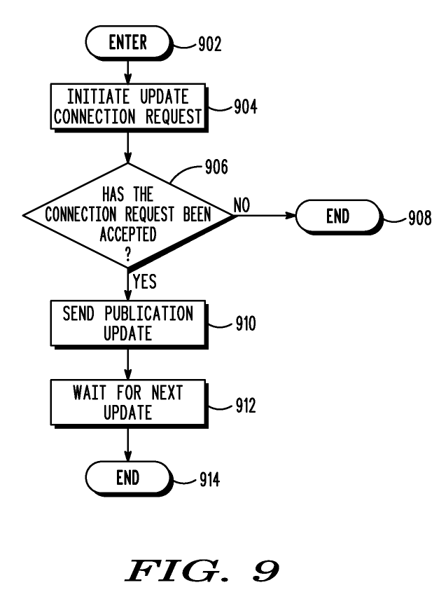

FIG. 9 is an operational flow diagram illustrating a process of a service provider publishing information to the information processing system 120. The operational flow diagram of FIG. 9 begins at step 902 and flows directly to step 904. The service provider, a step 904, initiates an update connection request with the information processing system 120. The service provider, at step 906, determines if the connection request has been accepted by the information processing system 120. If the result of this determination is negative, the control flow exits at step 908. If the result of this determination is positive, the service provider, at step 910, sends publication information to the information processing system 120. The service provider, at step 912, waits for another update where the control flow then returns to step 904.

Non-Limiting Examples

The present invention can be realized in hardware, software, or a combination of hardware and software. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

In general, the routines executed to implement the embodiments of the present invention, whether implemented as part of an operating system or a specific application, component, program, module, object or sequence of instructions may be referred to herein as a “program.” The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method, with a wireless device, of dynamically selecting a network for communicating data over, the method comprising:
initiating a search for a new access network;
transmitting, in response to the initiating, a network information request to an information processing system;
receiving network information associated with at least one access network from the information processing system;
selecting the new access network based on the received network information; and
connecting to the new access network.

2. The method of claim 1, wherein the initiating further comprises at least one of:
determining that a connection timer has expired;
determining that a current location is at least a distance from a serving base station that is greater than a given distance threshold; and
determining that at least one monitored motion vector indicates at least one of
motion in a given direction is detected;
motion is detected; and
motion in a given direction, and at a distance from the serving base station that is greater than a given distance threshold, is detected.

3. The method of claim 1, wherein the network information request includes:
a location profile request, wherein the location profile request comprises geographical location information identifying a current geographical location of the wireless device and requests network information associated with networks located within the geographical location of the wireless device.

4. The method of claim 1, wherein the network information request includes:
a request for network information associated with one of networks and cells providing a specific access type.

5. The method of claim 1, wherein selecting the new access is based on the received network information and a network selection policy.

6. The method of claim 5, wherein the network selection policy identifies at least one of:
a prioritized set of network service providers;
a prioritized set of access types;
connection charge requirements;
bandwidth requirements;
Quality of Service requirements;
signal quality requirements; and
Radio Frequency conditions.

7. The method of claim 5, wherein the network selection policy is defined by at least one of:
a user;
a service provider; and
a network provider.

8. The method of claim 1, wherein the received network information includes at least one of:
a network identifier for each network identified by the received network information;
access types provided by each network identified by the received network information;
bandwidth availability for each network identified by the received network information;
Quality of Service information associated with each network identified by the received network information; and
network usage costs.

9. The method of claim 1, further comprising:
detecting a plurality of access networks;
receiving network information from each detected network; and
recording the network information received from the plurality of access networks in memory.

10. The method of claim 9, further comprising:
transmitting the recorded network information received from the plurality of access networks to the information processing system.

11. The method of claim 1, wherein the information processing system is one of:
a third-party information processing system subscribed to by the wireless device; and
a network operator owned information processing system, wherein the network operator provides wireless communication services subscribed to by the wireless device

12. A wireless device, the wireless device comprising:
a memory;
a processor communicatively coupled to the memory; and
an access network manager communicatively coupled to the memory and the processor, the access network manager adapted to:
initiate a search for a new access network;
transmit, in response to the initiating, a network information request to an information processing system;
receive network information associated with at least one access network from the information processing system;
select the new access network based on the received network information; and
connect to the new access network.

13. The wireless device of claim 12, wherein the network information request includes at least one of:
a location profile request, wherein the location profile request comprises geographical location information identifying a current geographical location of the wireless device and requests network information associated with networks located within the geographical location of the wireless device; and
a request for network information associated with one of networks and cells providing a specific access type.

14. The wireless device of claim 12, wherein selecting the new access is based on the received network information and a network selection policy, wherein the network selection policy identifies at least one of:
a prioritized set of network service providers;
a prioritized set of access types;
connection charge requirements;
bandwidth requirements;
Quality of Service requirements;
signal quality requirements; and
Radio Frequency conditions.

15. The wireless device of claim 12, wherein the access network manager is further adapted to:
detect a plurality of access networks;
receive network information from each detected network;
record the network information received from the plurality of access networks in memory; and
transmit the recorded network information received from the plurality of access networks to the information processing system.

16. The wireless device of claim 12, wherein the information processing system is one of:
a third-party information processing system subscribed to by the wireless device; and
a network operator owned information processing system, wherein the network operator provides wireless communication services subscribed to by the wireless device

17. A wireless communication system, the wireless communication system comprising:
a plurality of access networks;
at least one information processing system communicatively coupled to at least one access network in the plurality of access networks; and
a plurality of wireless devices, wherein each wireless device is communicatively coupled to at least one access network in the plurality of access networks, and wherein at least one wireless device in the plurality of wireless devices comprises:
a memory;
a processor communicatively coupled to the memory; and
an access network manager communicatively coupled to the memory and the processor, the access network manager adapted to:
initiate a search for a new access network;
transmitting, in response to the initiating, a network information request to an information processing system;
receive network information associated with at least one access network from the information processing system;
select the new access network based on the received network information; and
connect to the new access network.

18. The wireless communication system of claim 17, wherein the network information request includes at least one of:
a location profile request, wherein the location profile request comprises geographical location information identifying a current geographical location of the wireless device and requests network information associated with networks located within the geographical location of the wireless device; and
a request for network information associated with one of networks and cells providing a specific access type.

19. The wireless communication system of claim 17, wherein selecting the new access is based on the received network information and a network selection policy, wherein the network selection policy identifies at least one of:
a prioritized set of network service providers;
a prioritized set of access types;
connection charge requirements;
bandwidth requirements;
Quality of Service requirements;
signal quality requirements; and
Radio Frequency conditions.

20. The wireless communication system of claim 17, wherein the access network manager is further adapted to:
detect a plurality of access networks;
receive network information from each detected network;
record the network information received from the plurality of access networks in memory; and
transmit the recorded network information received from the plurality of access networks to the information processing system.
